(19) United States
(12) Patent Application Publication
(10) Pub. No.: US 2023/0128684 A1
(43) Pub. Date: Apr. 27, 2023

(54) WEATHER ALERT SYSTEM

(71) Applicants: Britley A. Ritz, Smryna, GA (US); Timothy Ryan Nicholson, Jordan, MN (US)

(72) Inventors: Britley A. Ritz, Smryna, GA (US); Timothy Ryan Nicholson, Jordan, MN (US)

(21) Appl. No.: 18/048,335

(22) Filed: Oct. 20, 2022

Related U.S. Application Data
(60) Provisional application No. 63/270,256, filed on Oct. 21, 2021.

(51) Int. Cl. G08B 21/18

(52) U.S. Cl. CPC G08B 21/18

(57) ABSTRACT

A weather alert system having a human interface device that includes a processor and is attached to an attachment member. Disposed within the attachment member is a first antenna that is connected to the human interface device. A second antenna that works as a transceiver is connected to the processor and when a weather radio frequency is received the processor activates a first alarm based on a user's geographic location. In one example the human interface device is a watch and in another it includes an antenna device stored in a vehicle.

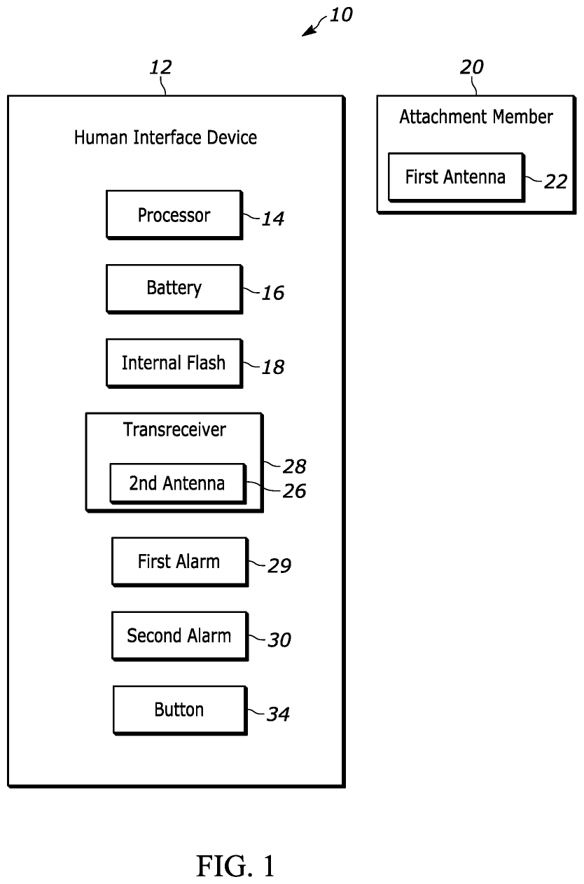

### CROSS REFERENCE TO RELATED APPLICATION

This application claims the benefit of U.S. Provisional Application Ser. No. 63/270,256 filed Oct. 21, 2021, the content of which is hereby incorporated by reference in its entirety.

### BACKGROUND OF THE INVENTION

The present invention is directed to a weather alert system and more particularly a weather alert system for users who are deaf, hard of hearing, and/or travelling.

Presently, weather alerts are provided through television and radio broadcasts, as well as transmitted to mobile phones. While useful, one depending upon their mobile phone cannot get an alert if the cell tower is down due to the storm.

Mobile phones not only do not have necessary weather antennas, but manufacturers have refused to allow the FCC to place a weather antenna in a mobile phone due to lack of space. Even if allowed, the antenna would be too condensed for a proper signal. Therefore, a need exists in the art for a system that will address these deficiencies.

An objective of the present invention is to provide a weather alert system that is used by individuals who are deaf, hard of hearing, and/or travelling.

A further objective of the present invention is to provide a weather alert system that receive an alert on a device other than a television, radio, or mobile phone.

These and other objectives will be apparent to one of ordinary skill in the art based upon the following written description, drawings, and claims.

### SUMMARY OF THE INVENTION

A weather alert system includes a human interface device having a processor attached to an attachment member. Disposed within the attachment member is a first antenna that is connected to the human interface device. A second antenna that works as a transceiver is connected to the processor and based upon a weather radio frequency received that is within a user's geographic location the processor activates a first alarm. In one example the human interface device is a watch and in another it includes an antenna device stored in a vehicle. The human interface device also includes internal power and an internal flash for firmware. Also, in one example, the attachment member is an adjustable wrist band.

The first antenna is adapted to receive GPS signals and frequencies ranging from 99 MHz through 200 MHz. In particular the first antenna is also adapted to receive NOAA frequencies at 162 MHz. The weather radio frequencies are issued by the National Weather Service and when received by the first antenna they are sent to the processor and if a user's GPS is located in a geographic watch area the first alarm is activated. In one example, the first alarm includes pre-charged LED lights positioned around a display on the human interface device that flash a color.

A second alarm is activated when a weather warning alert is received by the first antenna and transmitted to the processor. The human interface system has a button that turns off the first and second alarms. Also, the first and second alarms of the human interface device can be transmitted by the transceiver to the Bluetooth of a vehicle that pushes the alert to the vehicle. The system can also be downloaded to a mobile phone to push the alert to the mobile phone. Also, the system can have an open weather radio translator that locates VHF weather transmissions that are retransmitted at smaller wavelengths.

### BRIEF DESCRIPTION OF THE DRAWING

The FIGURE is a schematic view of the environment for a weather alert system.

### DETAILED DESCRIPTION

Referring to the Figures, a weather alert system 10 includes a human interface device 12 that preferably is worn, but also is portable for use with travel. The human interface device 12 is of any size, shape, and structure and in one example takes the form and function of a conventional watch similar to other smart devices that can perform health monitoring. Alternatively, the device 12 is a simplified antenna device stored in a vehicle.

In addition to conventional parts, the human interface device 12 includes a processor 14, internal power 16 (i.e. battery), and an internal flash 18 for firmware. Attached to the human interface device 12 is an attachment member 20 similar to an adjustable wrist band or the like that is breathable.

A first antenna 22 is disposed within the attachment member 20 and is connected to the device 12. The first antenna 22 is adapted to receive GPS signals and very high frequencies ranging from 99 MHz through 200 MHz, including National Oceanic and Atmospheric Administration (NOAA) frequencies which currently reside at 162 MHz. A second antenna 26, used as part of a transceiver 28, is connected to the processor 14.

The processor 14 manages the antennas 22 and 26, automatic gain control and an RF filter, licensed/open—IP processing to manage positioning, licensed or open—IP to manage Bluetooth, and ad hoc connectivity to a human interface device 12, which preferably is a mobile phone.

In operation, when idle, the human interface device 12 works in a conventional manner such as displaying time for a watch. When a weather watch alert is issued by the National Weather Service, weather radio frequencies are sent and will be received by a user, based on the user's GPS if they are located in the geographic watch area. If a signal is received by the first antenna 22, the signal is transmitted to the processor 14 and the processor activates a first alarm 29. The first alarm 29 is of any type and in one example includes pre-charged LED lights positioned around the display of the watch 12 that flash a color such as yellow. If a weather warning alert is sent, the signal is received by the first antenna 22, transmitted to the processor 14, which activates a second alarm 30, which is of any type and in one example a vibration member vibrates and red lights flash around the watch 12 display. The watch 12 has a button 34 that permits a user to manually turn off the alarms 29 and 30.

In addition, while travelling in a vehicle, the alarms 29 and 30 are transmitted from the transceiver 28 of the human interface device 12 to the Bluetooth of the vehicle and the Bluetooth will push the alert to the vehicle even if the radio is turned off. In addition, an application can be downloaded to a mobile phone that will allow alarms 29 and 30 to be pushed to the device 12.

In addition, the weather alert system 10 includes an open weather radio translator 40. The translator locates VHF weather transmissions and retransmits them in the clear at smaller wavelengths. The translator 40 can retransmit on several public space UHF bands and provides telemetry for better location digest. Also, the translator 40 provides hashing (data keys) to ensure integrity of signal and so that receivers may determine the quality and authenticity of the signal. Any of multiple types of devices may be used to translate the signal in the clear.

The non-internet bound personal device, which gathers weather SAME data and GPS telemetry for personal weather alerting and monitoring, can be integrated with a mobile device or other internet source for added accuracy.

From the above discussion and accompanying figures and claims it will be appreciated that the weather alert system 10 offers many advantages over the prior art. It will be appreciated further by those skilled in the art that other various modifications could be made to the device without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included in the spirit and purview of this application.

What is claimed is:

1. A weather alert system, comprising:
a human interface device having a processor attached to an attachment member;
a first antenna disposed within the attachment member and connected to the human interface device; and
a second antenna that works as a transceiver that is connected to the processor, wherein the processor activates a first alarm based upon weather radio frequencies received and a user's geographic location.

2. The system of claim 1 wherein the human interface device is a watch.

3. The system of claim 1 wherein the human interface device includes an antenna device stored in a vehicle.

4. The system of claim 1 wherein the human interface device includes internal power, and an internal flash for firmware.

5. The system of claim 1 wherein the attachment member is an adjustable wrist band.

6. The system of claim 1 wherein the first antenna is adapted to receive GPS signals and frequencies ranging from 99 MHz through 200 MHz.

7. The system of claim 1 wherein the first antenna is adapted to receive NOAA frequencies at 162 MHz.

8. The system of claim 1 wherein the weather radio frequencies are issued by the National Weather Service.

9. The system of claim 1 wherein the weather radio frequencies are received by the first antenna and sent to the processor and if a user's GPS is located in a geographic watch area the first alarm is activated.

10. The system of claim 1 wherein the first alarm includes pre-charged LED lights positioned around a display on the human interface device that flash a color.

11. The system of claim 1 wherein a second alarm is activated when a weather warning alert is received by the first antenna and transmitted to the processor.

12. The system of claim 11 wherein the human interface device has a button that turns off the first and second alarms.

13. The system of claim 11 wherein the first and second alarms are transmitted from the transceiver of the human interface device to the Bluetooth of a vehicle that pushes the alert to the vehicle.

14. The system of claim 1 wherein the system is downloaded to a mobile phone where the first and second alarms are pushed to the mobile phone.

15. The system of claim 1 further comprising an open weather radio translator that locates VHF weather transmissions that are retransmitted at smaller wavelengths.
